(19) United States
(12) Patent Application Publication
(10) Pub. No.: US 2017/0053583 A1
(43) Pub. Date: Feb. 23, 2017

(54) METHOD AND APPARATUS FOR SETTING THE TRANSPARENCY OF AN ON-SCREEN DISPLAY

(71) Applicants: LE HOLDINGS (BEIJING) CO., LTD., Beijing (CN); LE SHI ZHI XIN ELECTRONIC TECHNOLOGY (TIAN JIN) LIMITED, Tianjin (CN)

(72) Inventor: Wei LIU, Tianjin (CN)

(21) Appl. No.: 15/234,030

(22) Filed: Aug. 11, 2016

Related U.S. Application Data
(63) Continuation of application No. PCT/CN2016/082404, filed on May 17, 2016.

(30) Foreign Application Priority Data
Aug. 21, 2015 (CN) 201510520267.8

(51) Int. Cl. G09G 3/20

(52) U.S. Cl. CPC G09G 3/2003; G09G 2370/12; G09G 2320/0666

(57) ABSTRACT

Embodiments of the disclosure provide a method and apparatus for setting the transparency of an on-screen display so as to address the drawback in the prior art of impossibility to transmit Alpha data in a data transmission format in which transmission of the Alpha data is not supported. The method includes: a data transmitter and a data receiver preset data bits in which Alpha data are transmitted; the data transmitter transmits OSD data including the Alpha data transmitted in the preset data bits to the data receiver; the data receiver receives the OSD data and identifies the Alpha data transmitted in the preset data bits, to the OSD data.

### CROSS-REFERENCE TO RELATED APPLICATIONS

The present disclosure is a continuation of International Application No. PCT/CN2016/082404, filed on May 17, 2016, which is based upon and claims priority to Chinese Patent Application No. 201510520267.8, filed on Aug. 21, 2015, the entire contents of which are incorporated herein by reference.

### TECHNICAL FIELD

The present disclosure relates to the field of data processing, and particularly to a method and apparatus for setting the transparency of an on-screen display.

### BACKGROUND

If an On-screen Display (OSD) is applied to a display, then some special characters or graphic can be generated on a display screen, e.g., a display screen of a TV set or a personal computer, and if an operating user switches a channel, or adjusts a volume, a quality of picture, etc., then the current state will be displayed on the screen of the TV set so that the user can adjust respective parameters in a function menu displayed on the screen simply and variously.

As illustrated in FIG. 1 which is a schematic structural diagram of an existing processor in a smart TV system, the processor is connected respectively with an Ethernet module, a Wireless Fidelity (Wi-Fi) module/Bluetooth module, a power management module, a memory module, an audio system, and a display panel, where the processor is connected with the audio system via an inter-IC Sound Bus (I2S) interface. Video data processed by the processor are output to the display panel for displaying, and audio data are output by the audio system. The processor is further arranged thereon a High Definition Multimedia Interface (HDMI) 1 port, an HDMI 2 port, a low-noise block downconverter (LNB) port, a component port, and a Composite Video Broadcast Signal (CVBS) port, via which video data complying with different communication standards are transmitted in different data formats.

At present, OSD data are processed in the smart TV system in the following flow: the intelligent video processor superimposes the received video data onto the OSD data generated by the processor, and then transmit them to the display screen for displaying, where the transparency of the OSD data displayed on the display screen can be set by Alpha data in the V-by-one (an emerging high-speed serial interface data communication standard) format, for example, “A” in Alpha Red Green Blue (ARGB) In the video data represents Alpha data. By way of an example in which the intelligent video data processor receives the video data which are video data in the HDMI format, the intelligent video data processor can superimpose the video data in the HDMI format onto the data in the V-by-one format converted from OSD data generated by the processor, and then transmit them to the display screen for displaying.

The OSD data can be displayed for the video data processed in the smart TV system as described above, but while externally input video data are being played on the display screen of the smart TV set, if the user needs to adjust a display screen of the smart TV set, then the smart TV processor will output the generated OSD data, and then the video data will be superimposed onto the OSD data outside the processor; and since no Alpha data are set in the format of the HDMI port standard for transmitting the OSD data, the transparency of the OSD data can not be set although the external video data superimposed onto the OSD data are displayed, and if the transparency of the OSD data is not set, then a video picture being displayed on the display screen will be shielded by the OSD data, thus degrading the experience of the user.

As can be apparent, it is highly desirable in the prior art to address a technical problem of how to transmitting Alpha data in a data transmission format in which transmission of the Alpha data is not supported.

### SUMMARY

The disclosure provides a method and apparatus for setting the transparency of an on-screen display so as to address the drawback in the prior art of impossibility to transmit Alpha data in a data transmission format in which transmission of the Alpha data is not supported.

An embodiment of the disclosure provides a method for setting the transparency of an on-screen display, the method including:

presetting data bits in which Alpha data are transmitted;

transmitting OSD data which includes the Alpha data transmitted in the preset data bits;

receiving the OSD data;

identifying the Alpha data transmitted in the preset data bits, in the OSD data; and

setting the transparency of the on-screen display according to the Alpha data.

An embodiment of the disclosure provides an apparatus for setting the transparency of an on-screen display, the apparatus including:

at least one processor; and

a memory communicably connected with the at least one processor for storing instructions executable by the at least one processor, wherein execution of the instructions by the at least one processor causes the at least one processor to:

preset data bits in which Alpha data are transmitted;

transmit OSD data which includes the Alpha data transmitted in the preset data bits;

receive the OSD data;

identify the Alpha data transmitted in the preset data bits, in the OSD data; and

set the transparency of the on-screen display according to the Alpha data.

An embodiment of the disclosure provides a non-transitory computer-readable storage medium storing executable instructions that, when executed by an apparatus, cause the apparatus to:

preset data bits in which Alpha data are transmitted;

transmit OSD data which includes the Alpha data transmitted in the preset data bits;
receive the OSD data;

identify the Alpha data transmitted in the preset data bits, in the OSD data; and
set the transparency of the on-screen display according to the Alpha data identified.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic structural diagram of the processor of the smart TV system in the prior art;

FIG. 2a is a schematic diagram of setting the transparency of an on-screen display according to some embodiments of the disclosure;

FIG. 2b is a schematic diagram of transmitting OSD data by a transmitter according to some embodiments of the disclosure;

FIG. 2c is a schematic diagram of transmitting OSD data by a receiver according to some embodiments of the disclosure;

FIG. 3 is a schematic diagram of an disclosure scenario in which a user plays external video data on a display screen of a smart TV set according to some embodiments of the disclosure;

FIG. 4a is a schematic diagram of a data transmission sequence in which a processor of a smart TV set transmits video data using 30 RGB data bits according to some embodiments of the disclosure;

FIG. 4b is a schematic diagram of a data transmission sequence in which a processor of a smart TV set transmits video data and Alpha data in OSD data, using 30 RGB data bits according to some embodiments of the disclosure;

FIG. 4c is a schematic diagram of a data transmission sequence in which OSD data identified by an HDMI to V-by-one bridge are transmitted according to some embodiments of the disclosure;

FIG. 5 is a schematic structural diagram of an apparatus for setting the transparency of an on-screen display according to some embodiments of the disclosure; and

FIG. 6 is a schematic structural diagram of another apparatus for setting the transparency of an on-screen display according to some embodiments of the disclosure.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

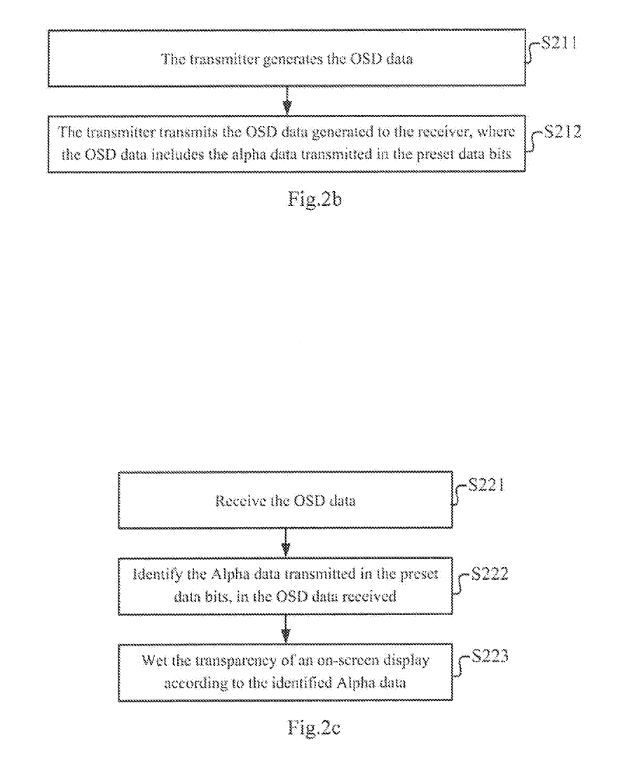

As illustrated in FIG. 2a, there is a flow chart of a method for setting the transparency of an on-screen display according to an embodiment of the disclosure, where the method ears include the following operations:

S21 is to preset data bits in which Alpha data are transmitted.

In a particular implementation, a data transmitter and a data receiver preset the same transmission protocol, and data bits in which Alpha data are transmitted. After the data bits in which Alpha data are transmitted are preset, the data transmitter can transmit OSD data by transmitting Alpha data in the preset data bits, and the data receiver can identify the OSD data in the preset data bits.

S22 is to transmit OSD data.

Here the OSD data transmitted include the Alpha data transmitted in the preset data bits.

S23 is to receive the OSD data.

S24 is to identify the Alpha data transmitted in the preset data bits, in the OSD data.

S25 is to preset the transparency of an on-screen display according to the Alpha data identified.

For the sake of better understanding of the embodiment of the disclosure, particular implementation flows in which the data transmitter transmits the OSD data, and the data receiver receives the OSD data will be described below respectively. Given the data bits in which Alpha data axe transmitted, which are preset by the data transmitter and the data receiver, as illustrated in FIG. 2b, the transmitter can transmit the OSD data to the receiver in the following operations:

S211. The transmitter generates the OSD data.

In a particular implementation, the transmitter generates the OSD data upon reception of a parameter adjustment instruction transmitted by a user. For example, if the transmitter is a processor of a smart TV set, then the user can transmit the parameter adjustment instruction to the processor of the smart TV set using a remote controller.

S212. The transmitter transmits the OSD data generated to the receiver, where the OSD data includes the alpha data transmitted in the preset data bits.

Preferably the transmitter can transmit the OSD data to the receiver using RGB data bits. For example, if the OSD data generated by the transmitter are OSD data complying with the HDMI format, then the transmitter can transmit the OSD data to the receiver via an HDMI port using the RGB data bits. The OSD data includes video data and the Alpha data, where the video data can be transmitted to the receiver using the RGB bits. Base on this, in the method for transmitting the OSD data according to the embodiment of the disclosure, the Alpha data can be transmitted using part of the RGB data bits.

In a particular implementation, the Alpha data in the OSD data can be transmitted to the receiver in any data transmission format in which transmission of the Alpha data is not supported, in the method above for transmitting OSD data, and the embodiment of the disclosure will be described taking data in the HDMI format only as an example, but will not be limited thereto.

As in the prior art of displays, video data are typically transmitted in 24 RGB data bits, 30 RGB data bits, and 36 RGB data bits, and if there are a large number of bits, then an image will be displayed at higher saturation on a display screen, where there are 8 data bits respectively for each of R, G, and B components in the 24-bit transmission scheme, 10 data bits respectively for each of R, G, and B components in the 30-bit transmission scheme, and 12 data bits respectively tor each of R, G, and B components in the 36-bit transmission scheme.

In order to alleviate an influence upon the hue of the image displayed on the display screen as many as possible, the Alpha data can be transmitted in 6 RGB data bits in an embodiment of the disclosure.

For example, if the video data and the Alpha data in the OSD data are transmitted in 30 RGB data bits, then the video data can be transmitted in 24 bits, and the Alpha data can be transmitted in the remaining 6 bits.

Preferably the Alpha data can be transmitted in two bits among the data bits for each of R, G, and B components, where these two data bits of each of R, G, and B components can be decided particularly as a result of negotiation between the transmitter and the receiver. For example, if the transmitter and the receiver decide as a result of their negotiation that the Alpha data in the OSD data are transmitted in 6 data bits of R[8]-R[9], G[8]-G[9], and B[8]-B[9], then the transmitter will transmit the vide data in the OSD data using 24 data bits of R[0]-R[7], G[0]-G[0], and B[0]-B[7].

For example, if the video data and the Alpha data in the OSD data are transmitted in 36 RGB data bits, then the video data can be transmitted in 30 bits, and the Alpha data can be transmitted in the remaining 6 bits. Preferably the Alpha data can be transmitted in two bits among the data bits for each of R, G, and B components. A like these two data bits of each of R, G, and B components can be decided particularly as a result of negotiation between the transmitter and the receiver. For example, if the transmitter and the receiver decide as a result of their negotiation that the Alpha data in the OSD data are transmitted in 6 data bits of R[10]-R[11], G[10]-[11], and B[10]-B[11], then the transmitter will transmit the vide data in the OSD data using 30 data bits of R[0]-R[9], G[0]-G[9], and B[0]-B[9].

Of course, in a particular implementation, if the video data and the Alpha data in the OSD data are transmitted in 36 RGB data bits, then alternatively the video data can be transmitted in 24 bits, and the Alpha data can be transmitted in the remaining 12 bits, in an disclosure scenario where the hue of the image displayed on the display screen is less demanded. Particularly the Alpha data can be transmitted in 4 bits among the data bits for each of R, G, and B components. Alike these four data bits of each of R, G, and B components can be decided particularly as a result of negotiation between the transmitter and the receiver. For example, if the transmitter and the receiver decide as a result of their negotiation that the Alpha data in the OSD data are transmitted in 12 data bits of R[8]-R[11], G[8]-G[11], and B[8]-B[11], then the transmitter will transmit the vide data in the OSD data using 24 data bits of R[0]-R[7], G[0]-G[7], and B[]-B[7].

Correspondingly the receiver can receive and identify the Alpha data using the data bits in which the Alpha data are transmitted, which are preset by the receiver and the transmitter, and particularly as illustrated in FIG. 2c, the receiver can receive the OSD data transmitted by the transmitter in the following flow:

S221 is to receive the OSD data.

The OSD data received by the receiver includes the Alpha data transmitted by the transmitter in the preset data bits.

Here the receiver can receive the OSD data via an HDMI port, and particularly the OSD data includes the Alpha data transmitted by the transmitter in RGB data bits decide as a result of pre-negotiation. Preferably the transmitter transmits the Alpha data using any two bits among the data bits for each component, in the RGB data.

S222. The receiver identifies the Alpha data transmitted in the preset data bits, in the OSD data received.

S223 is to set the transparency of an on-screen display according to the identified Alpha data.

Furthermore the receiver superimposes the OSD data for which the transparency of an on-screen display is set, onto a received external video signal, and then transmits them to a display screen for displaying.

For the sake of better understanding of the embodiments of the disclosure, a particular implementation of the embodiments of the disclosure will be described below by way of an example in which a processor of a smart TV set generates and transmits OSD data including Alpha data.

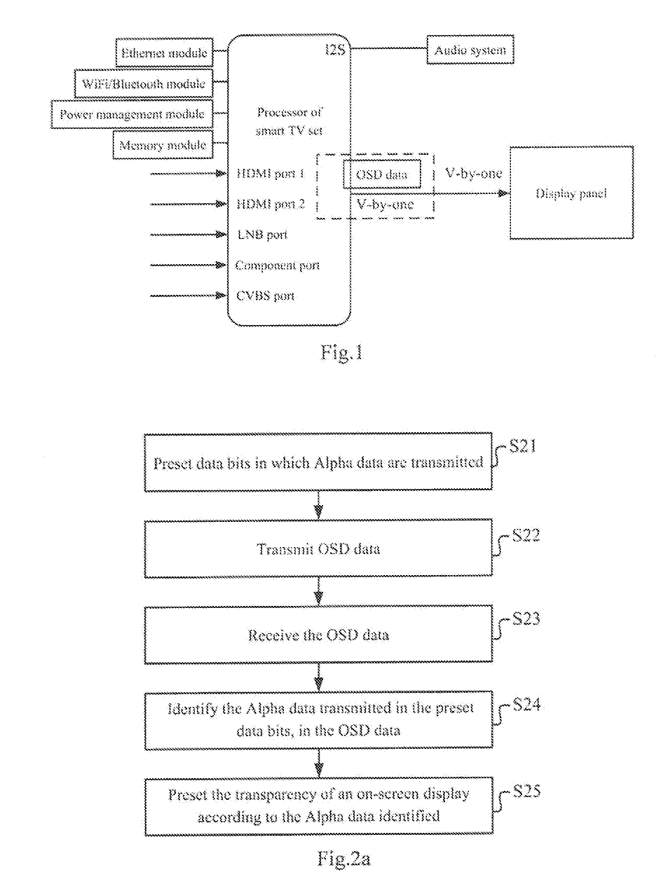

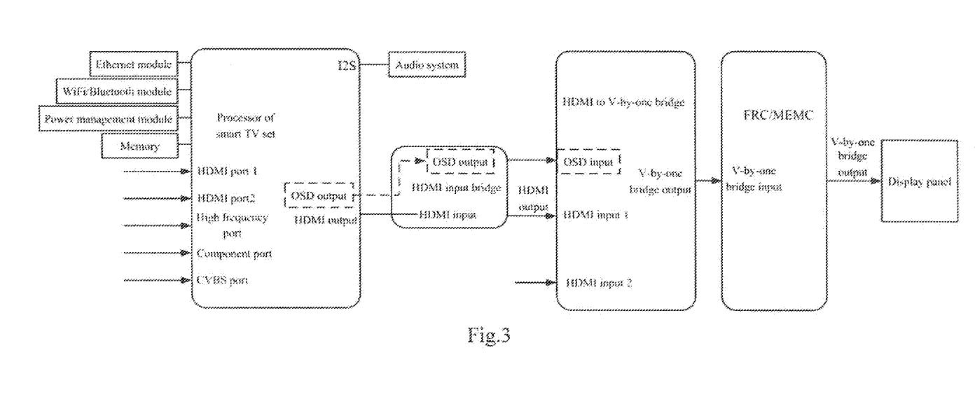

As illustrated in FIG. 3, there is a schematic diagram of an disclosure scenario in which a user plays external video data on a display screen of a smart TV set, and the system includes a processor of a smart TV set (structured the same as in FIG. 1, although a repeated description thereof will be omitted here), an HDMI input bridge, and an HDMI to V-by-one bridge, where the HDMI input bridge, and the HDMI to V-by-one bridge are configured to convert the format of data output by the processor of the smart TV set, and the HDMI to V-by-one bridge is provided with two HDMI ports including an HDMI 1 interface via which HDMI video data output by the processor of the smart TV set are received, and an HDMI 2 interface via which external video data are received. If a user watching the external video on the smart TV set needs to adjust a related parameter of the smart TV set (e.g., adjust a volume, adjust display contrast, etc.), then he or she will transmit a parameter adjustment instruction to the processor of the smart TV set using a remote controller of the smart TV set, and the processor of the smart TV set will generate OSD data, and transmit it to the HDMI to V-by-one bridge through the HDMI bridge, upon reception of the parameter adjustment parameter; and since the HDMI data transmission format does not support transmission of Alpha data In the OSD data, the OSD data transmuted to the HDMI to V-by-one bridge are OSD data including no Alpha data. Since the transparency of OSD data is set in the Alpha data, if the Alpha data are absent, then a picture displayed on a display screen will be shielded by the OSD data displayed on the display screen, thus degrading the experience of the user.

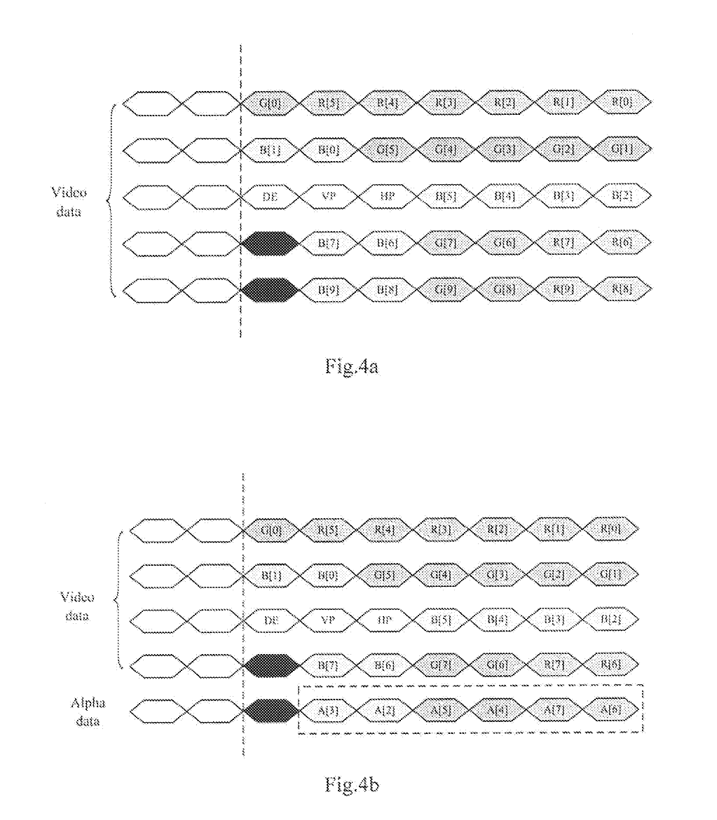

In view of this, in an embodiment of the disclosure, in order to transmit the Alpha data in the OSD data generated by the processor of the smart TV set to the HDMI to V-by-one bridge, the Alpha data can be transmitted in RGB data in which video data are transmitted, where the processor of the smart TV set and the HDMI to V-by-one bridge pre-negotiate about the data bits in which the Alpha data are transmitted, and if the video data are transmitted in 30 RGB data bits between the processor of the smart TV set and the HDMI to V-by-one bridge, then FIG. 4a illustrates a schematic diagram of a data transmission sequence in which the processor of the smart TV set transmits the video data using the 30 RGB-data bits.

By way of an example in which the Alpha data are transmitted between the processor of the smart TV set and the HDMI-to V-by-one bridge using 6 data bits of R[8]-R[9], G[8]-G[9], and B[8]-B[9], the processor of the smart TV set at the transmitter transmits the video data in the OSD data using R[0]-R[7], G[0]-G[0], and B[0]-B[7], and the Alpha data in the OSD data using R[8]-R[9], G[8]-G[9], and B[8]-B[9] among the 30 bits. FIG. 4b illustrates a schematic diagram of a data transmission sequence in which the processor of the smart TV set transmits the video data and the Alpha data in the OSD data, using the 30 RGB data bits.

The HDMI to V-by-one bridge at the receiver identifies the Alpha data transmitted in R[8]-R[9], G[8]-G[9], and B[8]-B[9], FIG. 4c illustrates a schematic diagram of a data transmission sequence in which the OSD data identified by the HDMI to V-by-one bridge are transmitted, where the OSD data include the video data and the Alpha data. The HDMI to V-by-one bridge sets the transparency of an on-screen display based on the Alpha data identified, and superimposes the OSD data for which the transparency of an on-screen display is set, onto a received external video signal, and then transmit them to the display screen for displaying.

So far in the embodiment of the disclosure, the Alpha data are transmitted between the processor of the smart TV set, and the HDMI to V-by-one bridge so that the HDMI to V-by-one bridge can set the corresponding transparency according to the Alpha data.

In the method for setting the transparency of an on-screen display according to the embodiment of the disclosure, the positions at which the Alpha data are transmitted are preset so that the transmitter can transmit the OSD data including the Alpha data to the receiver using the preset data bits, and the receiver can receive and identify the Alpha data, using the preset data bits, thus enabling the Alpha data to be transmitted so that the receiver can set the corresponding transparency according to the received Alpha data, thus avoiding such a problem that a picture currently displayed on the display screen may be shielded by the OSD data with the Alpha data being absent, which would otherwise degrade the experience of the user.

Based upon the same inventive idea, an embodiment of the disclosure further provides an apparatus for setting the transparency of an on-screen display, and since the apparatus addresses the problem under a similar principle to the methods above for transmitting and receiving OSD data for setting the transparency of an on-screen display respectively, reference can be made the implementations of the methods for an implementation of the apparatus, so a repeated description thereof will be omitted here.

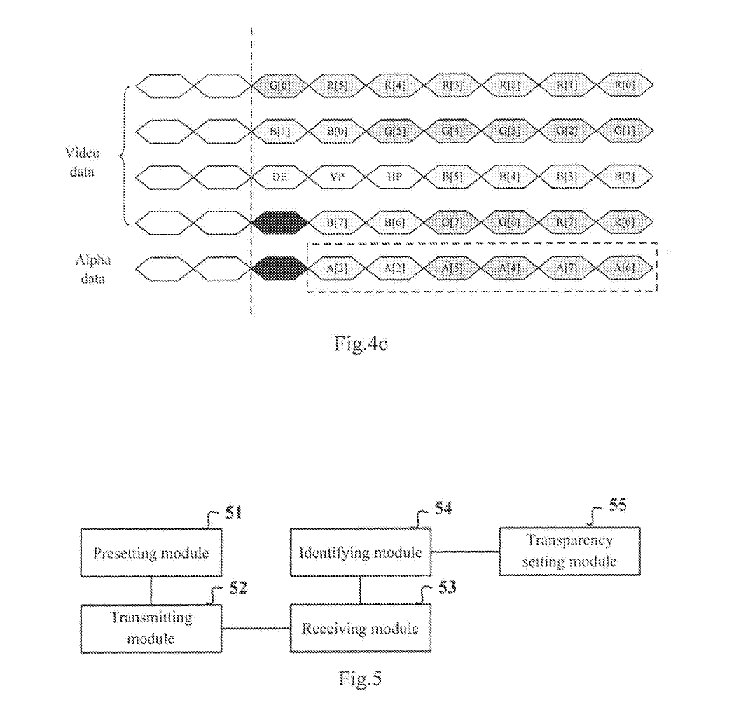

FIG. 5 illustrates a schematic structural diagram of an apparatus for setting the transparency of an on-screen display according to an embodiment of the disclosure, where the apparatus includes:

A presetting module 51 is configured to preset data bits in which Alpha data are transmitted;

A transmitting module 52 is configured to transmit OSD data including the Alpha data transmitted in the preset data bits;

A receiving module 53 is configured to receive the OSD data;

An identifying module 54 is configured to identify the Alpha data transmitted in the preset data bits, in the OSD data; and

A transparency setting module 55 is configured to set the transparency of the on-screen display according to the Alpha data identified by the identifying module 54.

Here the transmitting module 52 can be configured to transmit the OSD data using RGB data bits. Preferably the transmitting module 52 can be configured to transmit the Alpha data using any two data bits among data bits for each component in the RGB data.

In a particular implementation, the apparatus for setting the transparency of an on-screen display according to an embodiment of the disclosure can further includes:

A data superimposing module is configured to superimpose the OSD data for which the transparency of the on-screen display is set, onto a received external video signal, and then transmit them to a display screen for displaying.

Preferably the transmitting module 52 can be configured to transmit the OSD data with the HDMI protocol.

For the sake of a convenient description, the apparatus has been described by functionally dividing the apparatus into the respective modules (units) and describing them respectively. Of course, the respective modules (units) may be embodied in one or more pieces of software or hardware to put the disclosure into practice.

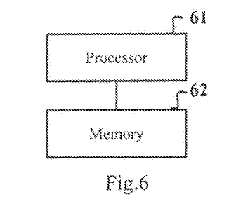

FIG. 6 illustrates a schematic structural diagram of an apparatus for setting the transparency of an on-screen display according to an embodiment of the disclosure, where the apparatus includes:

at least one processor 61; and

a memory 62 communicably connected with the at least one processor for storing instructions executable by the at least one processor, wherein execution of the instructions by the at least one processor causes the at least one processor to:

preset data bits in which Alpha data are transmitted;

transmit OSD data which comprises the Alpha data transmitted in the preset data bits;

receive the OSD data;

identity the Alpha data transmitted in the preset data bits, in the OSD data; and

set the transparency of the on-screen display according to the Alpha data identified.

Wherein that transmit the OSD data includes; transmitting the OSD data using RGB data bits.

Wherein the Alpha data are transmitted using any two data bits among data bits for each component in the RGB data.

Wherein that transmit the OSD data includes: transmitting the OSD data with the HDMI protocol.

An embodiment of the disclosure provides a non-transitory computer-readable storage medium storing executable instructions that when executed by an apparatus, cause the apparatus to:

preset data bits in which Alpha data are transmitted;

transmit OSD data which comprises the Alpha data transmitted in the preset data bits;

receive the OSD data;

identify the Alpha data transmitted in the preset data bits, in the OSD data; and

set the transparency of the on-screen display according to the Alpha data identified.

Wherein that transmit the OSD data includes: transmitting the OSD data using RGB data bits.

Wherein the Alpha data are transmitted using any two data bits among data bits for each component in the RGB data.

The non-transitory computer-readable storage medium further cause the apparatus to: Superimpose the OSD data for which the transparency of the on-screen display is set, onto a received external video signal, and transmitting, them to a display screen for displaying.

Wherein that transmit the OSD data includes: transmitting the OSD data with the HDMI protocol.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those ordinarily skilled in the art can appreciate that all or a part of the operations in the methods according to the embodiments described above can be performed by program instructing relevant hardware, where the programs can be stored in a computer readable storage medium, and the programs can perform one or a combination of the operations in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for setting the transparency of an on-screen display, OSD, comprising:
presetting data bits in which Alpha data are transmitted;
transmitting OSD data which comprises the Alpha data transmitted in the preset data bits;
receiving the OSD data;
identifying the Alpha data transmitted in the preset data bits, in the OSD data; and
setting the transparency of the on-screen display according to the Alpha data.

2. The method according to claim 1, wherein the transmitting the OSD data comprises:
transmitting the OSD data using RGB data bits..

3. The method according to claim 2, wherein the Alpha data are transmitted using any two data bits among data bits for each component in the RGB data.

4. The method according to claim 1, further comprising:
superimposing the OSD data for which the transparency of the on-screen display is set, onto a received external video signal, and transmitting them to a display screen for displaying.

5. The method according to claim 1, wherein the transmitting the OSD data comprises:
transmitting the OSD data with the HDMI protocol.

6. An apparatus for setting the transparency of an on-screen display, OSD, comprising:
at least one processor; and
a memory communicably connected with the at least one processor for storing instructions executable by the at least one processor, wherein execution of the instructions by the at least one processor causes the at least one processor to:
preset data bits in which Alpha data are transmitted;
transmit OSD data which comprises the Alpha data transmitted in the preset data bits;
receive the OSD data;
identify the Alpha data transmitted in the preset data bits, in the OSD data; and
set the transparency of the on-screen display according to the Alpha data identified.

7. The apparatus according to claim 6, wherein that transmit the OSD data comprises:
transmitting the OSD data using RGB data bits.

8. The apparatus according to claim 7, wherein the Alpha data are transmitted using any two data bits among data bits for each component in the RGB data.

9. The apparatus according to claim 6, wherein the at least one processor is further caused to superimpose the OSD data for which the transparency of the on-screen display is set, onto a received external video signal, and to transmit them to a display screen for displaying.

10. The apparatus according to claim 6, wherein that-transmit the OSD data comprises:
transmitting the OSD data with the HDMI protocol.

11. A non-transitory computer-readable storage medium storing executable instructions that, when executed by an apparatus, cause the apparatus to:
preset data bits in which Alpha data are transmitted;
transmit on-screen display, OSD, data which comprises the Alpha data transmitted in the preset data bits;
receive the OSD data;
identify the Alpha data transmitted in the preset data bits, in the OSD data; and set the transparency of the on-screen display according to the Alpha data identified.

12. The non-transitory computer-readable storage medium according to claim 11, wherein that transmit the OSD data comprises:
transmitting the OSD data using RGB data bits.

13. The non-transitory computer-readable storage medium according to claim 12, wherein the Alpha data are transmitted using any two data bits among data bits for each component in the RGB data.

14. The non-transitory computer-readable storage medium according to claim 11, further cause the apparatus to:
Superimpose the OSD data tor which the transparency of the on-screen display is set, onto a received external video signal, and transmitting them to a display screen for displaying.

15. The non-transitory computer-readable storage medium according to claim 11, wherein that transmit the OSD data comprises:
transmitting the OSD data with the HDMI protocol.
